(19) United States
(12) Patent Application Publication
(10) Pub. No.: US 2017/0039244 A1
(43) Pub. Date: Feb. 9, 2017

(54) SIMPLIFICATION OF SANKEY DIAGRAM

(71) Applicant: SAP SE, Walldorf (DE)

(72) Inventors: Alain Gauthier, Montreal (CA); James Zdralek, Montreal (CA); Ghufran Iftikhar, Vaudreuil-Dorion (CA); Rischa Poncik, Dorval (CA); Roy Ghorayeb, Montreal (CA); Farid Toubal-Seghir, Laval (CA); Wanling Zhang, Montreal (CA); Mohannad El-Jayousi, L'Ile-Bizard (CA)

(21) Appl. No.: 14/821,446

(22) Filed: Aug. 7, 2015

(51) Int. Cl. G06F 17/30; G06F 3/0481; G06T 11/20

(52) U.S. Cl. CPC G06F 17/30489; G06T 11/206; G06F 17/30554; G06F 17/30312; G06F 3/0481; G06T 2200/24

(57) ABSTRACT

The present disclosure generally relates to systems and methods for visualizing data. More specifically, the embodiments described herein generally relate to data manipulation algorithm(s) configured to position and/or identify unique node(s) with visualized data. The systems and methods retrieve one or more data structure(s), graphically align nodes having same level values, identify and remove duplicate nodes, and graphically render the data structures(s) as a Sankey diagram.

### CROSS-REFERENCE TO RELATED APPLICATIONS

This application is being filed concurrently with Attorney Docket No. 11884/544001 entitled “Generating Metadata and Visuals Related to Mined Data Habits,” Attorney Docket No. 11884/544101 entitled “Rendering Details from User Selections of Mined Data Habits,” Attorney Docket No. 11884/544201 entitled “Sankey Diagram Graphical User Interface Customization,” and Attorney Docket No. 11884/544301 entitled “Building Business Objects Based on Sankey Diagram,” the entireties of each of which is incorporated herein by reference in its entirety.

### FIELD OF THE DISCLOSURE

The embodiments of present disclosure generally relate to systems and methods for visualizing data. More specifically, the embodiments described herein generally relate to data manipulation algorithm(s) configured to position and/or identify unique node(s) with visualized data.

### BACKGROUND INFORMATION

Data visualization techniques may be used to graphically convey the meaning of information by helping users to understand and analyze data. Effective data visualization techniques can make data more readily accessible and more easily understandable. As the Internet continues to grow in size and complexity, data is generated at greater rates than ever before. As a result, data sets are typically so large and complex that manual procedures and traditional data processing applications are inadequate to handle analysis of such data sets. Nevertheless, visualization of these data sets can be helpful to identify business trends. In addition, data visualization may be used to troubleshoot and improve the provision of energy and computing resources, prevent diseases, combat crime, and the like.

One type of data visualization is a Sankey diagram. Conventionally, Sankey diagrams have been used to show density or magnitude, e.g., in flow of natural resources such as energy, petroleum, electricity, etc. Early applications of the Sankey diagram include Matthew Sankey's diagram of the energy efficiency of a steam engine and Charles Minard's diagram of Napoleon's Russian Campaign of 1812.

Unfortunately, the automatic generation of Sankey diagrams has remained problematic until now. For example, it has been difficult to adequately track various sequences of events that may include a variable number of interaction steps. Accordingly, the inventors have developed more effective systems and methods for displaying Sankey diagrams.

### BRIEF DESCRIPTION OF THE DRAWINGS

FIG. 1 illustrates a Sankey diagram according to an example embodiment of the present disclosure.

FIG. 2 illustrates a simplified data structure according to an example embodiment of the present disclosure.

FIG. 3 illustrates a visual representation of the simplified data structure according to an example embodiment of the present disclosure.

FIG. 4 illustrates nodes of a Sankey diagram according to an example embodiment of the present disclosure.

FIG. 5 illustrates a method for determining nodes of a Sankey diagram according to an example embodiment of the present disclosure.

FIG. 6 is a simplified block diagram of a system implementing the methods and systems described herein according to an embodiment of the present disclosure.

FIGS. 7A and 7B are block diagrams depicting an architectural overview of a database according to an example embodiment of the present disclosure.

FIG. 8 is flowchart of a method for mining a database to create a Sankey diagram according to an embodiment.

### DETAILED DESCRIPTION OF THE EMBODIMENTS

Reference will now be made in detail to the embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

Embodiments of user interfaces and associated methods for rendering graphical user interfaces for electronic device(s) are described. In some embodiments, the electronic device is a portable communication device (e.g., a mobile phone or tablet). The user interface may include a touchscreen and/or other input/output devices. It should be understood, however, that the user interfaces and associated methods may be applied to other devices, such as personal computers and laptops, which may include one or more other physical user interface devices, such as a keyboard and or mouse.

The systems and methods for rendering graphical user interfaces may be applied to a variety of software applications. The various applications that may be executed on an electronic device having at least one common physical user-interface device, such as a touchscreen. For example, the embodiments may be applied to applications that have been developed to manage business objects such as purchase orders, sales orders, contracts, service orders, etc. Although some example applications and user interfaces are described, the embodiments are not so limited.

Methods and systems of the present disclosure provide techniques to develop and render Sankey diagrams to model flow of processes. The methods and systems described herein find application in fields such as marketing, supply chain operation and management, monitoring electricity grid performance, public health and safety, and the like. In contrast to conventional Sankey diagrams, which are limited to illustrating energy flow, the methods and systems described herein provide a Sankey diagram to model data and processes traditionally not represented by Sankey diagrams, provide for interactive display and manipulation of data in a Sankey diagram, and respond to manipulations of data in the Sankey diagram by performing pre-definable functions.

Real-world processes such as business transactions may be challenging to model and analyze in the context of computer networking. One technological solution for modeling a real-world process is to use a “business object” to represent or model an aspect of the process. For instance, a business object may represent an action. By way of non-limiting example, the business object may represent one or more steps of: a marketing campaign, creating a newsletter, generating a sales report, and the like. A business object may be built or modified based on a Sankey diagram according to the methods and systems described herein.

One example of a real-world process is customer experience. A Sankey diagram may be useful to model customer experience. A customer's experience over time may be evaluated by a user such as vendor or market analyst to determine the efficacy of various marketing tactics. The customer's experience may be leveraged by the user to make decisions about future marketing tactics, e.g., to encourage completion of a purchase. For example, the information displayed in the Sankey diagram may help a user to understand why a customer did not complete a purchase. By way of non-limiting example, causes of incomplete purchases may include a lost Internet connection and a negative experience with a customer call center. Remedies may then be carried out to address issues arising in the customer experience. To encourage the customer to complete a purchase or to prevent future losses, the user may then trigger an action. Actions may include, among others, providing a discount to a customer and making a follow-up call to the customer. These triggered actions may be represented as business objects. For example, when an action is triggered, a business object may be generated.

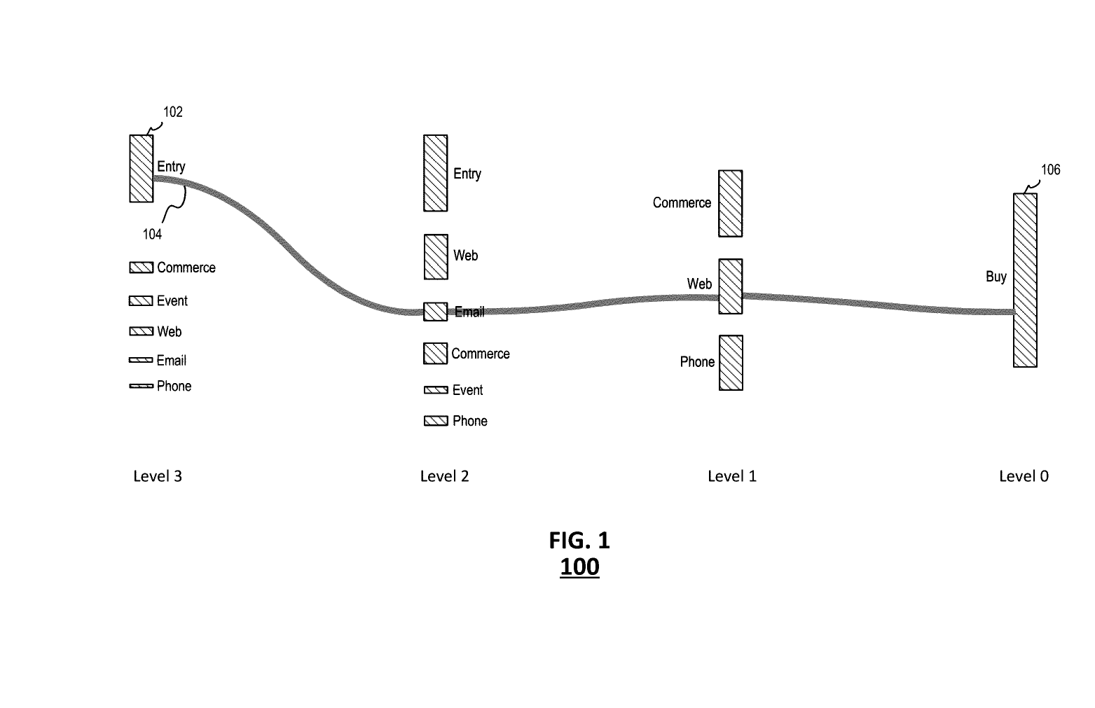

FIG. 1 is a Sankey diagram 100 according to an embodiment of the present disclosure. The Sankey diagram 100 may represent a sequence of steps taken in a marketing and purchase process. In such a process, a participant (also referred to as a “customer”) may encounter and interact with various platforms and campaigns. The customer may make various decisions and touch various nodes (e.g., commerce, event, web, email, phone, etc.) before ultimately making a purchase. Knowledge about a particular path or journey a customer takes can enable users to appropriately respond to issues that may arise in the path or journey. In addition to illustrating one participant's journey, the Sankey diagram 100 may compute and aggregate the collective paths or a subset of paths for a plurality of participants. By generating an aggregated display, a user of the Sankey diagram 100 may make decisions based on a critical mass of information.

The Sankey diagram 100 may include a target event 106, one or more nodes (represented by the shaded boxes), and one or more paths to reach the target event 106. A path may represent a customer experience over time. As shown, a path may traverse one or more nodes including: commerce, event, web, email, phone, etc. For example, “commerce” may represent a customer visit to an e-commerce website, “event” may represent customer participation in a marketing event such as an online discussion, “web” may represent customer interaction with a type of website such as a “social” networking website, “email” may represent a customer's reading or interaction with an email message related to the purchase, and “phone” may represent a customer's interaction with customer service. Other nodes are of course possible, including node staking place in the real world rather than in the virtual world. An “entry” may represent a step before a node, for example a beginning of observing and/or recording a customer's actions.

In an embodiment (as shown), a customer may reach the target event 106 via one or more nodes. Example path 104 shows how a customer may begin at node 102 and reach the target event 106 via nodes “email” and “web.” Each grouping of nodes is represented as a level, as shown in FIG. 1. For example, Level 0 includes the target event; Level 1 includes nodes commerce, web, and phone; Level 2 includes nodes entry, web, email, commerce, event, and phone; and Level 3 includes nodes entry, commerce, event, web, email, and phone. Some customers may make a purchase decision relatively quickly, while others may not. Those customers who make a purchase after an initial contact would be represented by a path between nodes at Level 1 and Level 0 (the purchase). A relatively short path would be one that begins at Level 2 and ends at Level 0, e.g., the path connecting entry (at Level 2), commerce (at Level 1), and buy (at Level 0). Those customers who may take more steps to the target event may be represented by a path at deeper levels.

In an embodiment, a path taken by a customer may be represented by a line connecting two or more nodes, as shown in the Sankey diagram 100. A thickness of a path may represent a density of that path such that the more customers that use that path to reach the target event, the thicker the line. The paths may represent trends in how customers make a purchase. Example path 104 shows how a customer may begin at node 102 and reach the target event 106 via nodes “email” and “web.” The path is represented by a relatively thin line, which means that this is relatively less popular manner to reach the target event, “Buy.”

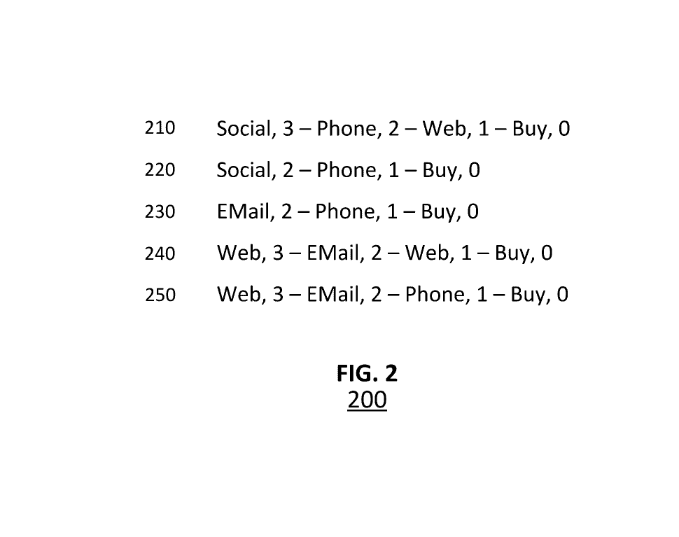

FIG. 2 illustrates a simplified data structure 200 according to an example embodiment of the present disclosure. As shown in FIG. 2, the example data structure 200 includes a plurality of entries 210, 220, 230, 240, and 250. In the illustrated example, each of entries 210-250 represents a sequence of events (i.e., nodes) that occurs in advance of a “Buy” event. In addition, within each of entries 210-250, a plurality of nodes and their respective levels may be identified and stored.

As can be understood from example data structure 200, a subset of entries may identify the same nodes at the same level. For example, entries 210 and 240 both indicate node “Web” at level “1.” As will be described below, the embodiments of the present disclosure may detect identical nodes and remove duplicates in order to generate a graphical rendering that may be more easily understood by a user.

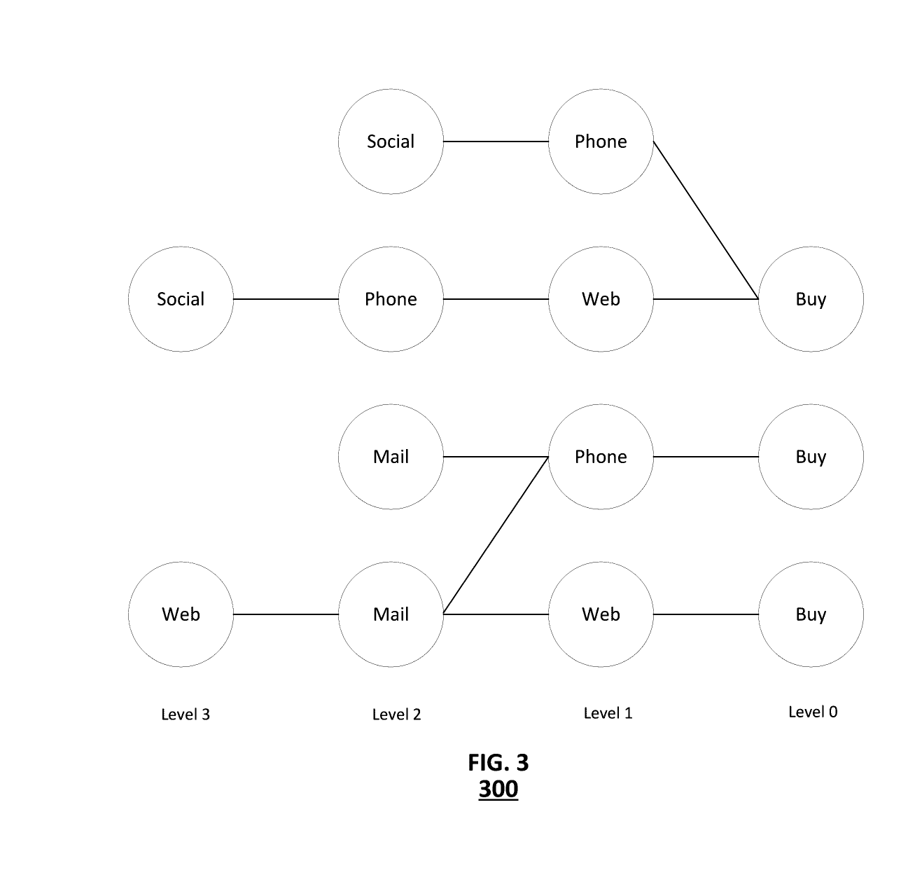

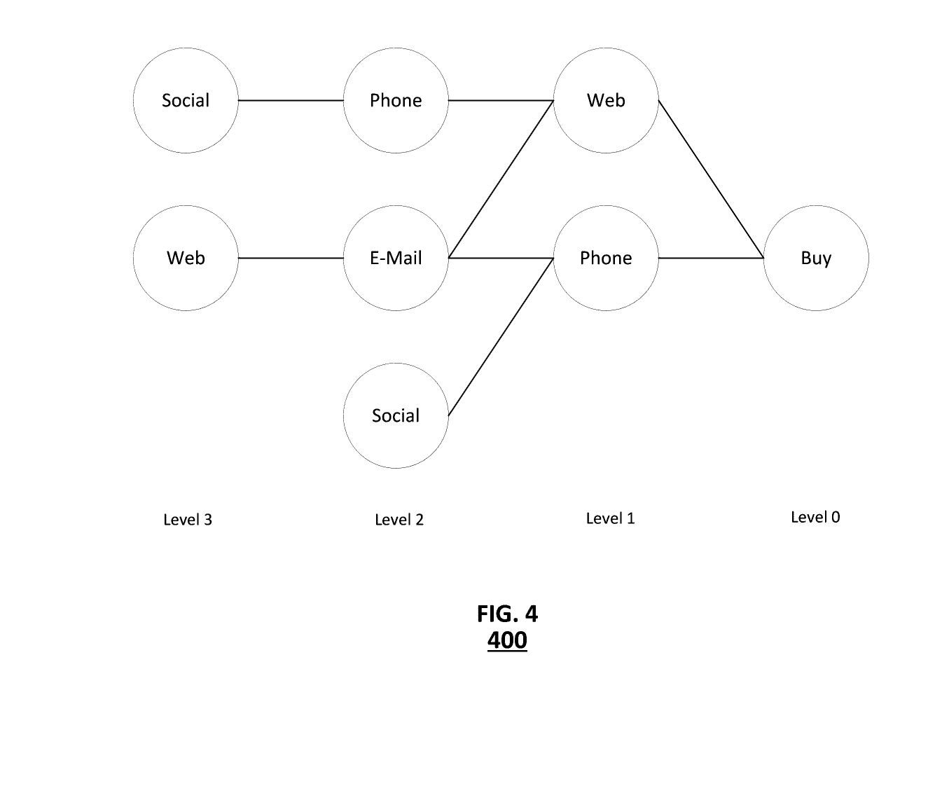

FIG. 3 illustrates a visual representation 300 of the simplified data structure 200 according to an example embodiment of the present disclosure. As shown in FIG. 3, each of entries 210-250 is graphically depicted in visual representation 300. In addition, visual representation 300 is a rendering of entries 210-250 in advance of the removal of duplicate nodes. By contrast, FIG. 4 illustrates nodes of a Sankey diagram 400 according to an example embodiment of the present disclosure. Sankey diagram 400 is a rendering of entries 210-250 subsequent to the removal of duplicate nodes.

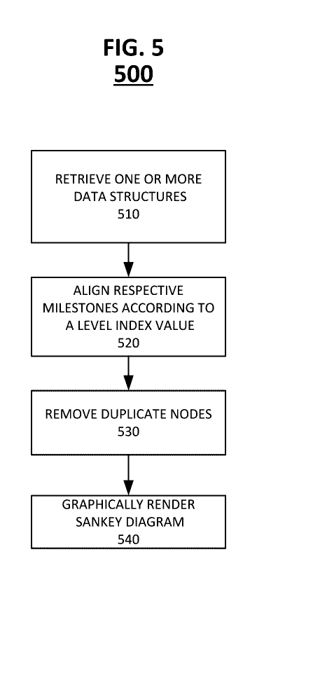

FIG. 5 illustrates a method 500 for determining nodes of a Sankey diagram according to an example embodiment of the present disclosure. At 510, the method 500 may retrieve one or more data structures. The data structures may be retrieved from a backend server and/or user-interface server. Alternatively, the data structures may be locally stored on a host device. Next, at 520, the method 500 may graphically align nodes having same level values. The method 500 may then proceed to identify and remove duplicate nodes, at 530. Lastly, at 540, the method 500 may graphically render the Sankey diagram.

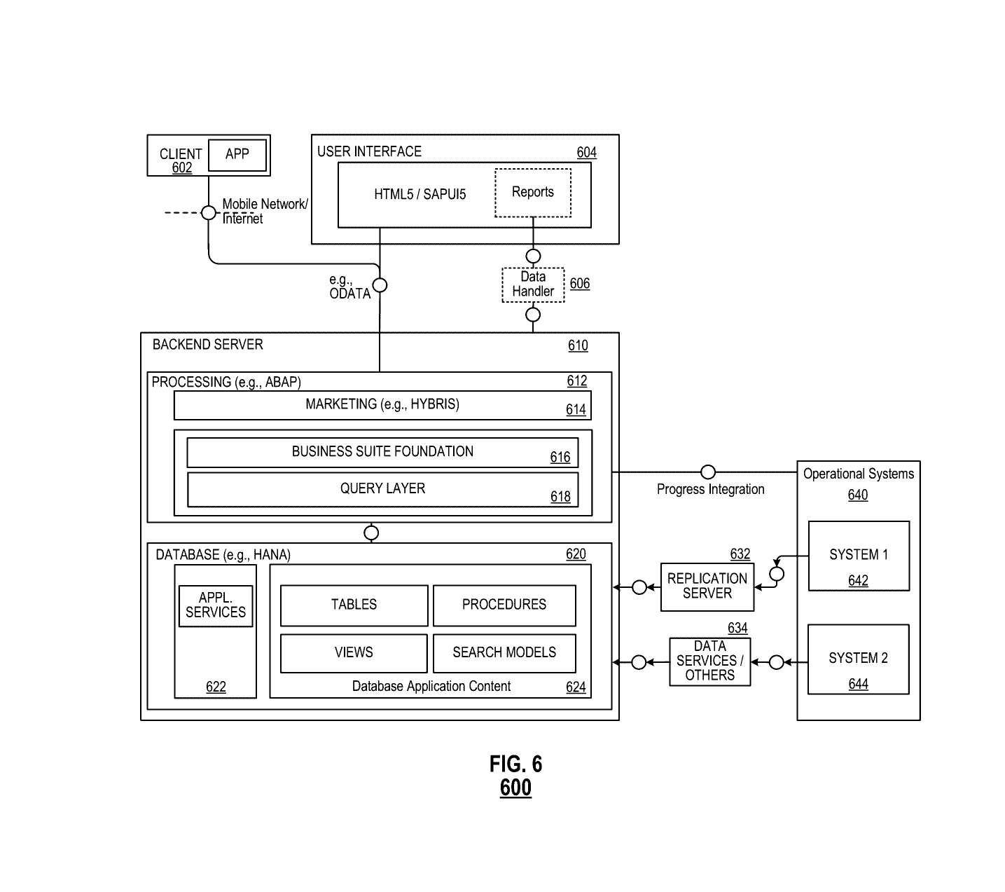

FIG. 6 is a system diagram depicting an architectural overview of a networked system 600 suitable for use with embodiments of the present disclosure. As shown in FIG. 6, the networked system 600 includes client device 602, user interface server 604, and backend server 610.

The networked system 600 includes one or more client devices 602, being network accessible via an Internet connection, and connected to a user interface server 604 and a backend server 610. Client device 602 may include a variety of devices such as, for example, a mobile device (e.g., mobile phone or smartphone), a personal computer, a laptop, a tablet, and the like. In addition, client device 602 may host one or more client applications, such as a client journey application.

A client journey application may mine large amounts of user interaction data stored within data sources 620 of backend server 610. The client journey application may utilize such user interaction data to provide and graphically render trends in user interactions for a respective business product according to the methods described herein. For example, when many users buy a product, the client journey application may graphically render various channels (also referred to as paths or links) that customers traverse to purchase the given product. The various purchasing channels and their respective frequencies (e.g., a frequency of use) may be mined from data sources 620, and graphically rendered by a client device 602 of networked system 600.

Client device 602 and user interface server 604 may be configured to exchange data with an enterprise data system, such as a backend server 610. In addition, user interface server 604 may generate and render user interfaces and/or reports based upon the exchanged data. User interface server 604 may utilize a variety of interfaced technologies. Some example interface technologies include HTML5, SAP® UI5, SAP®-WebDynpro, SAP® Gui, Perl, and the like. In addition, the user interface technology may operate in conjunction with business object platforms for visualizing business objects, such as SAP® Business Object Platform (SBOP), SAP® Business Intelligence Platform (SBIP), and the like.

User interface server 604 may generate interface code at runtime. However, depending on the interface technology, some embodiments may implement functions of the user interface server 604 on the client-side. For example, functions of the user interface server 604 may be implemented at the client device 602 on a browser using HTML5, JavaScript, CSS, or on a device using ObjectiveC. Thus, in some implementations, implementation of user interface server 604 may be optional.

The backend server 610 may be configured to process request(s), retrieve data, and/or perform data operations as an appropriate response to a request, and return a response for transmission back to the client device 602 or user interface server 604. In the example configuration depicted in FIG. 6, the backend server 610 may include one or more advanced business application programming (ABAP) modules 612, such as marketing module 614, which may be a Hybris® marketing module. For example, marketing module 614 may be configured to track and store user interactions, such as user shopping history, product browsing history, purchase history, and associated product information. In some instances, marketing module 614 may be further configured to track and store a particular user's interactions across multiple devices of the user. ABAP modules 612 may further include additional modules, such as business suite foundation module 616 and query layer 618 that may be configured to facilitate the exchange of data between the marketing module 614 and database 620.

The backend server 610 may further include one or more data sources 620. In the example depicted in FIG. 600, data source 620 may include application support modules 622 and database content 624 that may include a variety of tables, views, search models, search procedures, and the like. In addition to internal data sources 620, backend server 610 may further be coupled to a variety of external data sources 640. For example, external systems 642 and 644 may be coupled to the backend server 610 via replication server 632 and/or other data services 634, respectively.

Some example external data sources may include transactional information such as contact information, sales activities, quotations, and sales orders from CRM (customer relationship management) and ERP (enterprise resource planning) systems. In some instances, the backend server 610 may aggregate data from multiple backend servers. Within backend server 610, a variety of data, may be quickly aggregated without compromising backend or overall system performance. In some instances, various data may be represented using virtual data models (VDMs) to enable faster data aggregation. Here, a plurality of VDMs may be aggregated into fewer, or even a single VDM. Thus, aggregated data may be presented along one or more displays of a client journey application.

In addition, the backend server 610 may be implemented by or coupled to an in-memory database. In-memory databases are located within the main memory of a computer system or a coupled device, which provides the advantage of faster data access and faster program execution. In-memory databases also enable real-time operation on a computer or device, or on multiple computers or devices communicating through wired or network connections. An example of an in-memory database is the SAP® high-performance analytic appliance (HANA®). However, the embodiments are not limited to any particular in-memory database technology.

The various components networked system 600, such as client device 602, user interface server 604, and backend server 610, may be connected using known and expected network technologies, such as an Internet connection. For example, an OData connection may be used between the client device 602 and backend server 610, or between user interface server 604 and backend server 610. In another example, a data handler 606 may be configured to exchange data between user interface server 604 and backend server 610. Here, the data handler 606 may include SBOP and SBIP functions.

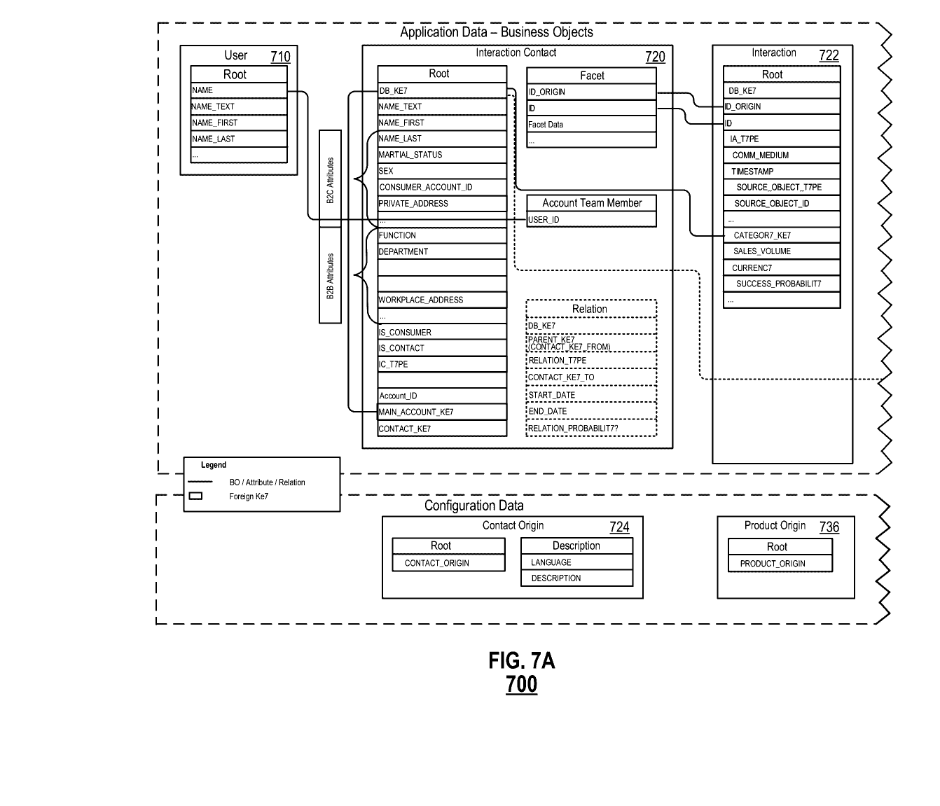

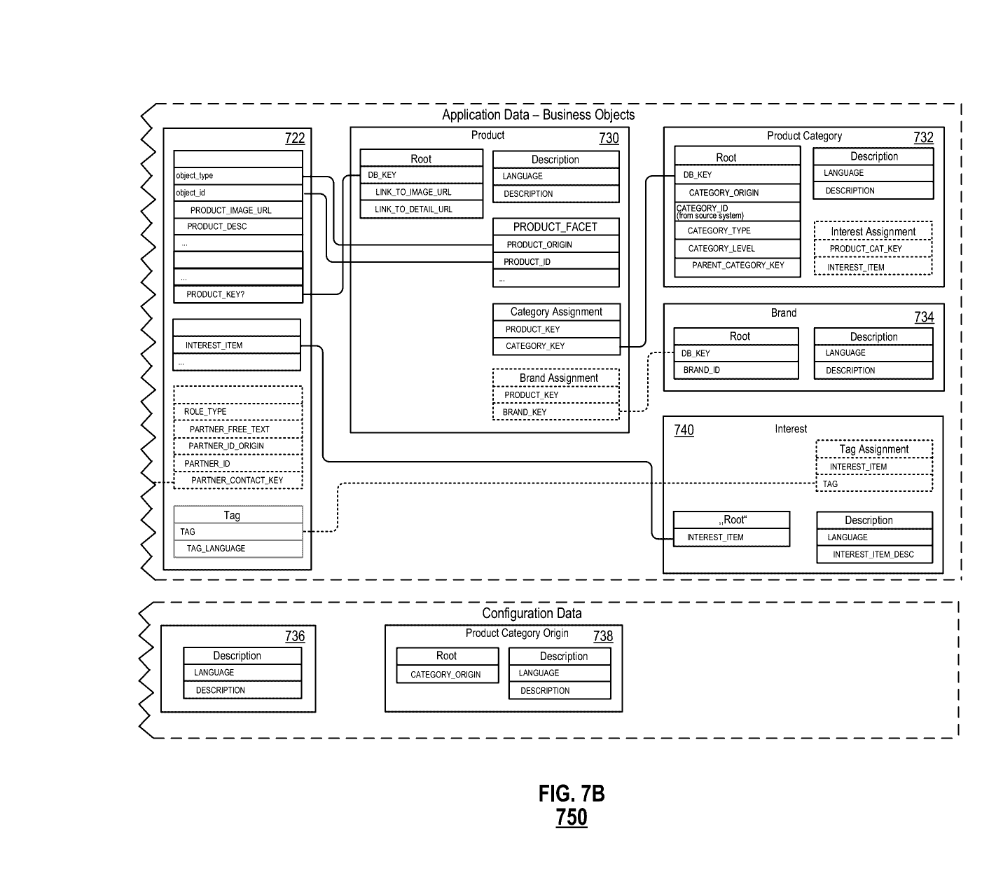

FIGS. 7A and 7B are block diagrams depicting an architectural overview of a database 700 and 750 according to an example embodiment of the present disclosure. As shown in FIGS. 7A and 7B, the database includes a plurality of application and configuration data tables that may be used to track and store user interactions (e.g., user shopping history, product browsing history, purchase history, and associated product information). Example application data tables include user table 710, interaction contact table 720, interaction table 722, product table 730, product category table 732, brand table 734, and interests table 740. In addition, example configuration tables include contact origin table 724, product origin table 736, and product category origin table 738.

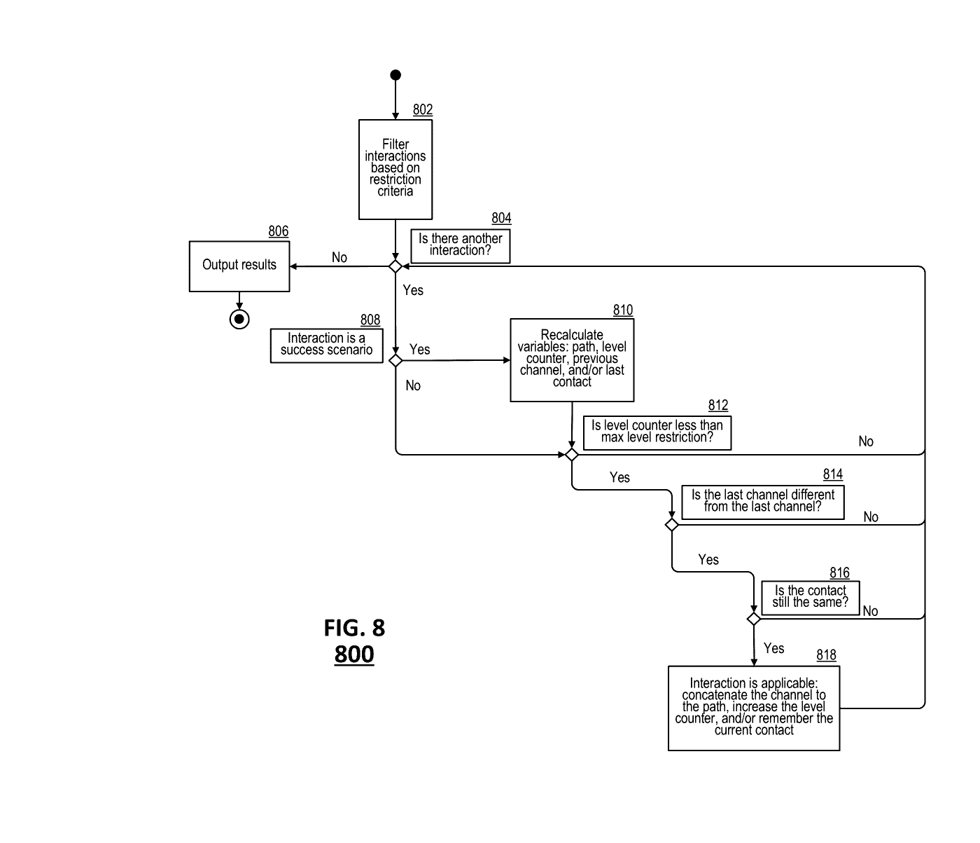

FIG. 8 illustrates a method 800 for mining a database according to an example embodiment of the present invention. At the outset, a user of the client device may filter interactions based on restriction criteria, at 802. For example, restriction criteria may include a particular product, product category, group of products, particular brand, and/or the like.

Next, at 804, the method 800 determines whether another respective interaction has occurred. Here, the method 800 may periodically determine whether other respective interactions have occurred. Alternatively, step 804 may be triggered by a change to one of the data sources. If no other respective interactions have occurred, the method 800 may proceed to output search results, at 806. As discussed above, the search results may be supplied to a requesting user interface server and/or client device. If another respective interaction has occurred, the method 800 may proceed to 808.

At 808, the method 800 determines whether the respective interaction is a success scenario (e.g., purchase of a product). If the respective interaction is a success scenario, one or more variables (e.g., path, level counter, previous channel, last contact, and/or the like) used for graphically rendering the user interaction data may be recalculated at 810. In an embodiment, after the recalculation, the method 800 may proceed to steps 812-816. In an embodiment, if the interaction is not a success scenario, the method 800 may proceed to steps 812-816.

At step 812, the level counter variable may be compared to a maximum level restriction. For example, the comparison of the level counter to a maximum level restriction may be used to ensure that a frequently traversed journey does not visually obstruct other journeys, if graphically rendered. If the level counter is not less than a maximum level restriction, the method 800 may proceed to output results, at 806. On the other hand, if the level counter is less than a maximum level restriction, the method 800 may proceed to 814.

At 814, the method 800 determines whether a respective interaction has changed channels. In other words, the method 800 determines whether the previous channel of the respective interaction is the same as its current channel. If the channel has not changed, the method 800 may proceed to output results, at 806. On the other hand, if the channel has changed, the method 800 may proceed to 816.

At 816, the method 800 determines whether contact information for the respective interaction has changed. If the contact information has not changed, the method 800 may proceed to output results, at 806. On the other hand, if the contact information has changed, the method 800 may proceed to 818. At 818, the method 800 may concatenate the channel to the path, increase the level counter, and/or store contact information. The method 8100 may then proceed to output results at 806.

While the description here pertains to construction and manipulation of a Sankey diagram in a marketing context, the concepts described here apply as well to other applications, for example processes in which a process participant has one or more interactions or nodes that can be tracked, stored, analyzed, and depicted in a visual representation or interpretation. For example, the concepts apply as well to supply chain operation and management, and monitoring electricity grid performance, and the like. For instance, methods and systems may construct, render, and update a Sankey diagram of a supply chain or power outage map, which methods and systems may benefit from improved computer operating efficiency.

Representing data in a Sankey diagram in the manner described herein has many advantages. For instance, data that would other be presented in a table and be cumbersome or tedious to understand may instead be presented in a Sankey diagram, which may allow for understanding of the trajectory of actions of a customer or a group of customers as well as a density of customer interactions. In addition to the Sankey diagram, metadata also may be generated to store relationships between interaction records per unit time. Such relationship information may not be explicitly stored in the database. Thus, the metadata further enhances the graphical representations of the Sankey diagram.

Although the foregoing description includes several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular means, materials and embodiments, the disclosure is not intended to be limited to the particulars disclosed; rather the disclosure extends to all functionally equivalent structures, methods, and uses such as are within the scope of the appended claims.

As used in the appended claims, the term “computer-readable medium” may include a single medium or multiple media, such as a centralized or distributed database, and/or associated caches and servers that store one or more sets of instructions. The term shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

The present specification describes components and functions that may be implemented in particular embodiments which may operate in accordance with one or more particular standards and protocols. However, the disclosure is not limited to such standards and protocols. Such standards periodically may be superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

For example, operation of the disclosed embodiments has been described in the context of servers and terminals that implement storage apparatus such as databases. These systems can be embodied in electronic devices or integrated circuits, such as application specific integrated circuits, field programmable gate arrays and/or digital signal processors. Alternatively, they can be embodied in computer programs that execute on personal computers, notebook computers, tablets, smartphones or computer servers. Such computer programs typically are stored in physical storage media such as electronic-, magnetic- and/or optically-based storage devices, where they may be read to a processor, under control of an operating system and executed. And, of course, these components may be provided as hybrid systems that distribute functionality across dedicated hardware components and programmed general-purpose processors, as desired.

In addition, in the foregoing Detailed Description, various features may be grouped or described together the purpose of streamlining the disclosure. This disclosure is not to be interpreted as reflecting an intention that all such features are required to provide an operable embodiment, nor that the claimed embodiments require more features than are expressly recited in each claim. Rather, as the following claims reflect, subject matter may be directed to less than all of the features of any of the disclosed embodiments. Thus, the following claims are incorporated into the Detailed Description, with each claim standing on its own as defining separately claimed subject matter.

Also, where certain claims recite methods, sequence of recitation of a particular method in a claim does not require that that sequence is essential to an operable claim. Rather, particular method elements or steps could be executed in different orders without departing from the scope or spirit of the disclosure.

What is claimed is:

1. A method comprising:
retrieving one or more data structures;
graphically aligning nodes having same level values;
identifying and removing duplicate nodes; and
graphically rendering the data structures(s) as a Sankey diagram.

2. The method of claim 1, wherein data structure(s) are retrieved from a backend server.

3. The method of claim 1, wherein data structure(s) are retrieved from a user-interface server.

4. The method of claim 1, wherein data structure(s) are retrieved from a non-transitory memory of a host device.

5. The method of claim 1, wherein the data structure includes a plurality of entries, each of the plurality of entries including a sequence of node identifiers and respective level values.

6. The method of claim 1, wherein the Sankey diagram includes a target event, at least one node to represent an event in a journey, and at least one path connecting the at least one node to the target event.

7. A non-transitory computer readable storage medium storing one or more testing programs configured to be executed by a processor, the one or more programs comprising instructions for:
retrieving one or more data structure(s);
graphically aligning nodes having same level values;
identifying and removing duplicate nodes; and
graphically rendering the data structures(s) as a Sankey diagram.

8. The non-transitory computer readable storage medium of claim 7, wherein data structure(s) are retrieved from a backend server.

9. The non-transitory computer readable storage medium of claim 7, wherein data structure(s) are retrieved from a user-interface server.

10. The non-transitory computer readable storage medium of claim 7, wherein data structure(s) are locally retrieved.

11. The non-transitory computer readable storage medium of claim 7, wherein the data structure(s) include a plurality of entries, each of the plurality of entries including a sequence of node identifiers and respective level values.

12. The non-transitory computer readable storage medium of claim 7, wherein the Sankey diagram includes a target event, at least one node to represent an event in a journey, and at least one path connecting the at least one node to the target event.

13. An system comprising:
one or more processors; and
memory storing one or more testing programs for execution by the one or more processors, the one or more programs including instructions for:
retrieving one or more data structure(s);
graphically aligning nodes having same level values;
identifying and removing duplicate nodes; and
graphically rendering the data structures(s) as a Sankey diagram.

14. The system according to claim 13, wherein data structure(s) are retrieved from a backend server.

15. The system according to claim 13, wherein data structure(s) are retrieved from a user-interface server.

16. The system according to claim 13, wherein data structure(s) are locally retrieved.

17. The system according to claim 13, wherein the data structure includes a plurality of entries, each of the plurality of entries including a sequence of node identifiers and respective level values.

18. The system according to claim 13, wherein the Sankey diagram includes a target event, at least one node to represent an event in a journey, and at least one path connecting the at least one node to the target event.
